(19) United States
(12) Patent Application Publication
(10) Pub. No.: US 2026/0166578 A1
(43) Pub. Date: Jun. 18, 2026

(54) NOZZLE COLLISION-DETECTION APPARATUS AND METHOD

(71) Applicant: SEMES CO., LTD., Cheonan-si (KR)

(72) Inventor: Soo Young PARK, Chungcheongnam-do (KR)

(73) Assignee: SEMES CO., LTD., Cheonan-si (KR)

(21) Appl. No.: 19/385,714

(22) Filed: Nov. 11, 2025

(30) Foreign Application Priority Data
Dec. 13, 2024 (KR) 10-2024-0186345

(51) Int. Cl. B05B 12/00; B05B 3/00; G06T 1/00; G06T 7/215

(52) U.S. Cl. CPC B05B 12/00; B05B 3/00; G06T 1/0014; G06T 7/215

(57) ABSTRACT

A nozzle collision-detection method is provided that prevents collisions among two or more nozzles by monitoring their movements in real time. The nozzle collision-detection method is performed by a computing device and includes: generating, within an orthogonal coordinate system, a first nozzle image corresponding to a first nozzle and a second nozzle image corresponding to a second nozzle; moving the first nozzle image according to first encoder information and moving the second nozzle image according to second encoder information; when the first nozzle image is at a first position and the second nozzle image is at a second position, generating a first projection image and a second projection image by projecting the first nozzle image and the second nozzle image from a first side of the orthogonal coordinate system; and determining whether a collision occurs between the first nozzle and the second nozzle by analyzing the first projection image and the second projection image.

### CROSS-REFERENCE TO RELATED APPLICATION

This application claims priority from Korean Patent Application No. 10-2024-0186345 filed on Dec. 13, 2024 in the Korean Intellectual Property Office, and all the benefits accruing therefrom under 35 U.S.C. 119, the contents of which in its entirety are herein incorporated by reference.

### BACKGROUND

### 1. Field

The present disclosure relates to a nozzle collision-detection apparatus and method.

### 2. Description of the Related Art

As semiconductor processes become increasingly sophisticated, the operation of chemical solutions discharged onto a substrate is also being optimized. For example, the switching time between a chemical solution discharged onto the substrate and another chemical solution is minimized, and the gap between the substrate and the discharge outlet is reduced to minimize solution rebound. In addition, two or more nozzles are often required to simultaneously move over the substrate. A recipe configuration for the operation of two or more nozzles is necessary. However, collisions between nozzles may occur due to human error or hardware timing mismatches.

To prevent this, an interlock recipe may be used. An interlock recipe is a method of preventing recipe misconfiguration. However, in complex situations, such as when two or more nozzles perform different scanning operations in the same step, it is difficult to identify collisions in advance. Moreover, if various delay options are applied to nozzle driving, it is also difficult to compute while accounting for them.

Alternatively, a method of monitoring a load or a position error of a motor attached to a nozzle may be used. However, this method can detect only after collisions between nozzles have occurred, which may result in hardware damage. In addition, detection may not be possible depending on the fastening condition between the nozzle and the motor.

### SUMMARY

An objective of the present disclosure is to provide a nozzle collision-detection apparatus for preventing collisions between nozzles by monitoring the movements of two or more nozzles in real time.

Another objective of the present disclosure is to provide a nozzle collision-detection method for preventing collisions between nozzles by monitoring the movements of two or more nozzles in real time.

The objectives of the present disclosure are not limited to those mentioned above, and other objectives not explicitly stated will be clearly understood by those skilled in the art based on the following description.

According to an aspect of the present disclosure, a nozzle collision-detection method performed by a computing device and includes: generating, within an orthogonal coordinate system, a first nozzle image corresponding to a first nozzle and a second nozzle image corresponding to a second nozzle; moving the first nozzle image according to first encoder information and moving the second nozzle image according to second encoder information; when the first nozzle image is at a first position and the second nozzle image is at a second position, generating a first projection image and a second projection image by projecting the first nozzle image and the second nozzle image from a first side of the orthogonal coordinate system; and determining whether a collision occurs between the first nozzle and the second nozzle by analyzing the first projection image and the second projection image

According to another aspect of the present disclosure, a nozzle collision-detection method is performed by a computing device, the method includes: generating, within an orthogonal coordinate system, a first nozzle image corresponding to a first nozzle and a second nozzle image corresponding to a second nozzle; calculating, based on first encoder information, a first rotation amount of a first motor that drives the first nozzle, and calculating, based on the first rotation amount, a first arcuate-motion position of the first nozzle image; calculating, based on second encoder information, a second rotation amount of a second motor that drives the second nozzle, and calculating, based on the second rotation amount, a second arcuate-motion position of the second nozzle image; and determining whether a collision occurs between the first nozzle and the second nozzle by analyzing the first arcuate-motion position and the second arcuate-motion position.

According to still another aspect of the present disclosure, a nozzle collision-detection apparatus includes a communication unit; a display; a processor; and a memory storing instructions that, when executed by the processor, cause the processor to: generate, within an orthogonal coordinate system, a first nozzle image corresponding to a first nozzle and a second nozzle image corresponding to a second nozzle; move the first nozzle image according to first encoder information and move the second nozzle image according to second encoder information; when the first nozzle image is at a first position and the second nozzle image is at a second position, generate a first projection image and a second projection image by projecting the first nozzle image and the second nozzle image from a first side of the orthogonal coordinate system; and determine whether a collision occurs between the first nozzle and the second nozzle by analyzing the first projection image and the second projection image.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing exemplary embodiments thereof in detail with reference to the attached drawings, in which:

FIG. 1 is a plan view for explaining a semiconductor manufacturing apparatus to which a nozzle collision-detection apparatus according to some embodiments of the present disclosure is applied;

FIG. 2 is a block diagram for explaining the operation of a nozzle collision-detection apparatus according to some embodiments of the present disclosure;

FIG. 3 is a diagram for explaining a user interface generated by the nozzle collision-detection apparatus according to some embodiments of the present disclosure;

FIG. 4 is a diagram for explaining a first nozzle image depicted in FIG. 3;

FIG. 5 is a diagram for explaining a second nozzle image depicted in FIG. 3;

FIGS. 6 and 7 are diagrams for explaining a nozzle collision-detection method according to some embodiments of the present disclosure;

FIG. 8 is a diagram for explaining the nozzle collision-detection method according to some embodiments of the present disclosure;

FIG. 9 is a flowchart for explaining the nozzle collision-detection method according to some embodiments of the present disclosure;

FIG. 10 is a flowchart for explaining the nozzle collision-detection method according to some embodiments of the present disclosure; and

FIG. 11 is a block diagram for explaining a nozzle collision-detection apparatus according to some embodiments of the present disclosure.

### DETAILED DESCRIPTION

Hereinafter, preferred embodiments of the present disclosure will be described in detail with reference to the accompanying drawings. The advantages and features of the present disclosure, and methods of achieving them, will be apparent from the embodiments described below in detail with reference to the drawings. However, the present disclosure is not limited to the embodiments disclosed herein but may be embodied in various forms. Rather, the embodiments are provided so that the present disclosure is complete and to fully convey the scope of the invention to those skilled in the art. The present disclosure is defined only by the claims. Throughout the specification, the same reference numerals denote the same elements.

Spatially relative terms such as “below,” “beneath,” “lower,” “above,” and “upper” may be used to conveniently describe the relationship of one element or component to another element or component as illustrated in the drawings. Spatially relative terms are intended to encompass different orientations of a device or element in use or operation in addition to the orientations depicted in the drawings. For example, if the device in the drawings is turned over, an element described as being “below” or “beneath” another element may be positioned “above” the other element. Thus, the exemplary term “below” may encompass both below and above directions. The device may also be oriented in other directions, and accordingly, spatially relative terms may be interpreted based on orientation.

Although the terms “first,” “second,” and the like may be used to describe various elements, components, and/or sections, these elements, components, and/or sections are not limited by such terms. These terms are used only to distinguish one element, component, or section from another. Accordingly, a first element, component, or section described below may be a second element, component, or section without departing from the scope of the present disclosure.

Hereinafter, embodiments of the present disclosure will be described in detail with reference to the accompanying drawings. In the description with reference to the drawings, the same reference numerals will be assigned to the same or corresponding elements regardless of figure numbers, and redundant descriptions thereof will be omitted.

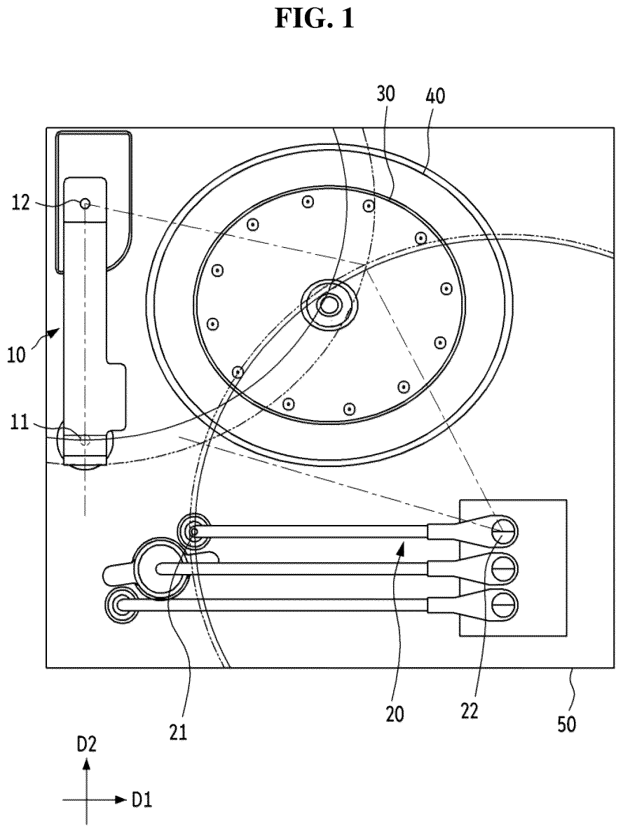

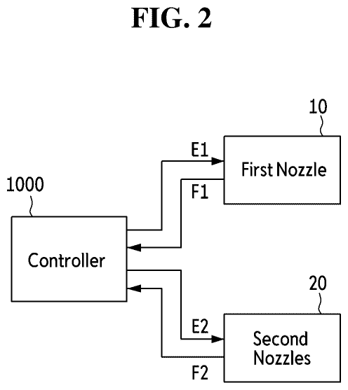

FIG. 1 is a plan view for explaining a semiconductor manufacturing apparatus to which a nozzle collision-detection apparatus according to some embodiments of the present disclosure is applied. FIG. 2 is a block diagram for explaining the operation of the nozzle collision-detection apparatus according to some embodiments of the present disclosure.

Referring first to FIG. 1, the semiconductor manufacturing apparatus according to some embodiments of the present disclosure includes a chamber 50, a supporter 30, bowls 40, and nozzles (10 and 20). In addition, a controller (not illustrated) controls at least one of the chamber 50, the supporter 30, the bowls 40, and the nozzles (10 and 20).

The chamber 50 provides a processing space in its interior. The supporter 30, the bowls 40, and the nozzles (10 and 20) are arranged in the processing space.

A substrate is placed on the supporter 30, and the supporter 30 rotates while the nozzles (10 and 20) discharge a chemical solution onto the substrate.

For example, a first nozzle 10 is installed on one side along a first direction D1 of the supporter 30. A plurality of second nozzles 20 may be installed on one side in a second direction D2 of the supporter 30. In a standby state, the second nozzles 20 extend along the first direction D1 and may be arranged side-by-side.

One side of the first nozzle 10 is connected to a first shaft 12, and a discharge outlet 11 is provided at the other side of the first nozzle 10. The first nozzle 10 performs an arcuate motion about the first shaft 12.

One side of each of the second nozzles 20 is connected to a corresponding second shaft 22, and a discharge outlet 21 is provided at the other side of each of the second nozzles 20. The second nozzles 20 perform an arcuate motion about the respective second shafts 22.

The bowls 40 are formed to surround the supporter 30. The bowls 40 include multiple layers. For example, when the first nozzle 10 discharges a first chemical solution, a first bowl among the bowls 40 may be used to collect the first chemical solution. In addition, when the second nozzles 20 discharge a second chemical solution, a second bowl among the bowls 40 may be used to collect the second chemical solution.

Referring to FIG. 2, a controller 1000 (or a nozzle collision-detection apparatus) controls operations of the first nozzle 10 and the second nozzles 20.

To control operation of the first nozzle 10, the controller 1000 provides first encoder information E1. The first nozzle 10 operates based on the first encoder information E1. For example, the first encoder information E1 corresponds to a first rotation amount of a first motor that drives the first nozzle 10. For example, if the first encoder information E1 is 10, the first rotation amount of the first motor may be 30 degrees, and if the first encoder information E1 is 20, the first rotation amount of the first motor may be 60 degrees. According to the first rotation amount of the first motor, the first nozzle 10 performs an arcuate motion. A result of the arcuate motion of the first nozzle 10 is provided to the controller 1000 as first feedback F1.

To control operation of the second nozzles 20, the controller 1000 provides second encoder information E2. The second nozzles 20 operate based on the second encoder information E2. For example, the second encoder information E2 corresponds to a second rotation amount of second motors that drive the second nozzles 20. According to the second rotation amount of the second motors, the second nozzles 20 perform an arcuate motion. A result of the arcuate motion of the second nozzles 20 is provided to the controller 1000 as second feedback F2.

Before or while moving the first nozzle 10 and the second nozzles 20, the controller 1000 may determine whether the first nozzle 10 and the second nozzles 20 will collide.

As will be described in detail below, the controller 1000 generates, in an orthogonal coordinate system, a first nozzle image corresponding to the first nozzle 10 and a second nozzle image corresponding to the second nozzles 20. Then, the controller 1000 moves the first nozzle image according to the first encoder information E1 and moves the second nozzle image according to the second encoder information E2. When the first nozzle image is at a first position and the second nozzle image is at a second position, the controller 1000 projects the first and second nozzle images from a first side of the orthogonal coordinate system, thereby generating a first projection image and a second projection image. By analyzing the first and second projection images, the controller 1000 determines whether a collision occurs between the first and second nozzles 10 and 20.

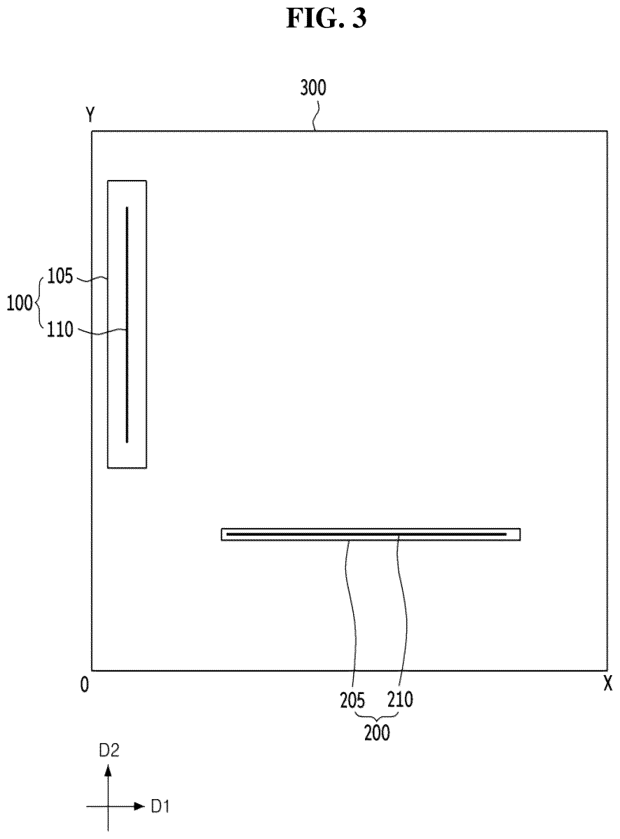

FIG. 3 is a diagram for explaining a user interface generated by the nozzle collision-detection apparatus according to some embodiments of the present disclosure.

Referring to FIG. 3, the controller 1000 generates, within an orthogonal coordinate system 300, a first nozzle image 100 and a second nozzle image 200.

The first nozzle image 100 corresponds to the first nozzle 10 in FIG. 1, and the second nozzle image 200 corresponds to the second nozzles 20 in FIG. 1.

The first nozzle image 100 includes a first control image 110 and a first outline image 105.

The first control image 110 is an image whose movement is controlled by the first encoder information E1.

The first outline image 105 surrounds the first control image 110 and is formed based on the outline of the first nozzle 10. The first outline image 105 may be a simplified polygonal image of the first nozzle 10. As illustrated, the first outline image 105 may be represented as a rectangle, but is not limited thereto. For example, the first outline image 105 may also be represented as a triangle, a pentagon, or a hexagon. The first outline image 105 moves together with movement of the first control image 110.

The second nozzle image 200 includes a second control image 210 and a second outline image 205.

The second control image 210 is an image whose movement is controlled by the second encoder information E2.

The second outline image 205 surrounds the second control image 210 and is formed based on the outline of the second nozzles 20. The second outline image 205 may be a simplified polygonal image of the second nozzles 20. As illustrated, the second outline image 205 may be represented as a rectangle, but is not limited thereto. The second outline image 205 moves together with movement of the second control image 210.

FIG. 1 illustrates three second nozzles 20, but only one second nozzle image 200 is illustrated in FIG. 3 for convenience of explanation.

The orthogonal coordinate system 300 is expressed as an X-Y coordinate system with the lower-left corner as the origin, but is not limited thereto. Using the values illustrated in FIG. 3, the position of each of the first and second nozzle images 100 and 200 may be represented as X-Y coordinates.

When the first and second nozzle images 100 and 200 are in a standby state (i.e., when the first and second nozzle images 100 and 200 are not moving), the first nozzle image 100 may be parallel to the Y-axis, and the second nozzle image 200 may be parallel to the X-axis.

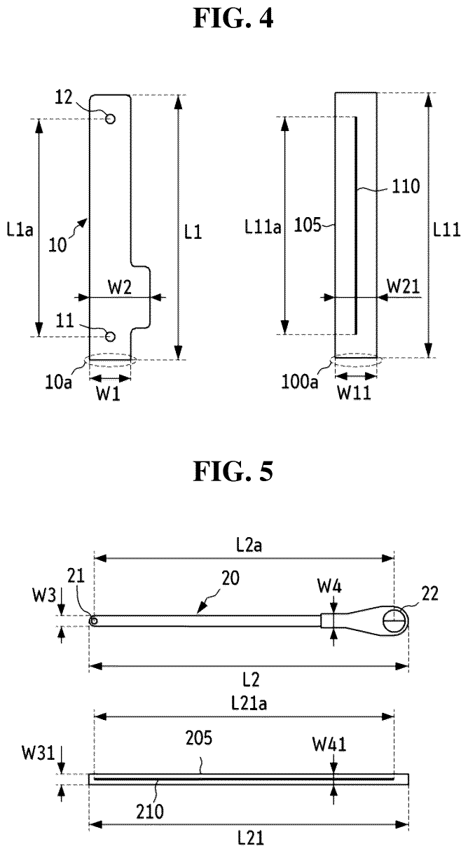

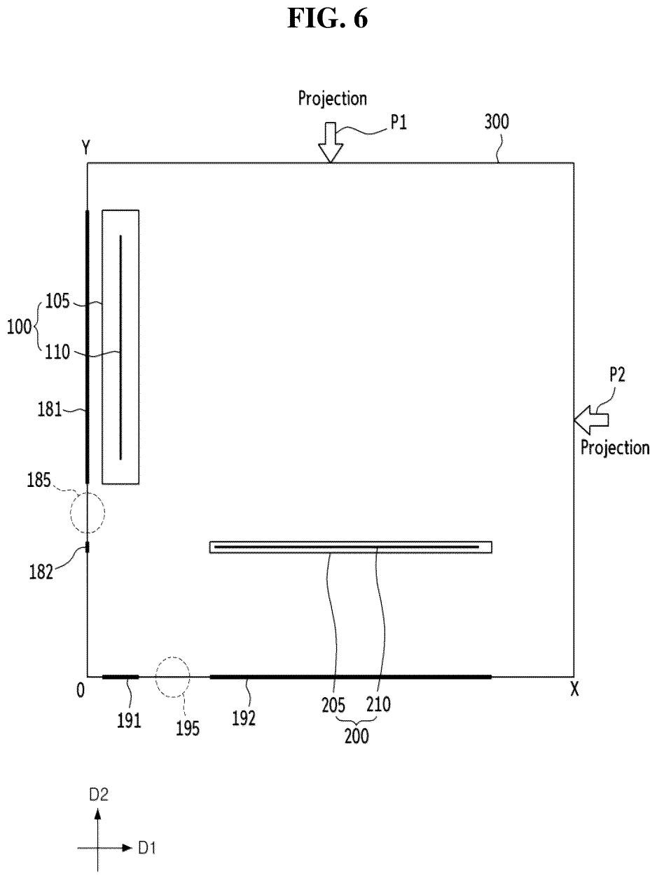

Hereinafter, the first nozzle image 100 corresponding to the first nozzle 10 and the second nozzle image 200 corresponding to the second nozzles 20 will be described with reference to FIGS. 4 and 5.

FIG. 4 is a diagram for explaining the first nozzle image depicted in FIG. 3. FIG. 5 is a diagram for explaining the second nozzle image depicted in FIG. 3.

Referring to FIG. 4, one side of the first nozzle 10 is connected to the first shaft 12, and the first discharge outlet 11 is provided at the other side of the first nozzle 10. A length L1 of the first nozzle 10 denotes the distance between opposite ends of the first nozzle 10 in one direction. The width of the first nozzle 10 may be non-uniform. For example, the width of an end region 10a of the first nozzle 10 is W1, and the maximum width in a middle region of the first nozzle 10 is W2.

The first outline image 105 of the first nozzle image 100 is formed based on the outline of the first nozzle 10. Since it is more important to compute quickly and accurately than to make the first outline image 105 resemble the exact outline of the first nozzle 10, the first outline image 105 may be simplified.

Specifically, the first outline image 105 may be simplified to a rectangle.

Here, a length L11 of the first outline image 105 corresponds to the length L1 of the first nozzle 10.

In addition, a width W11 of the first outline image 105 corresponds to the width W1 of the end region 10a of the first nozzle 10. Even if a width W2 of the middle region of the first nozzle 10 is greater than the width W1 of the end region 10a, the width W11 is determined based on the width W1 of the end region 10a. This is because, when the first nozzle image 100 is moved to check for a collision, a collision mainly occurs at an end region 100a of the first nozzle image 100. Therefore, the width W11 of the end region 100a is highly significant when determining the occurrence of a collision. The width W11 of the end region 100a may be equal to or greater than the width W1 of the end region 10a of the first nozzle 10. A width W21 of a middle region of the first outline image 105 may be the same as the width W11 of the end region 100a to conservatively determine the probability of collision.

Consequently, the maximum distance (i.e., L11) of the first outline image 105 in a first direction D1 is the same as the maximum distance (i.e., L1) of the first nozzle 10 in the first direction D1, and the maximum distance (i.e., W11) of the first outline image 105 in a second direction D2 may be different from the maximum distance (i.e., W2) of the first nozzle 10 in the second direction D2.

Meanwhile, a length L1a of the first nozzle 10 denotes the distance between the first shaft 12 and the first discharge outlet 11. A first control image 110 is simplified to a straight line, and a length L11a of the first control image 110 corresponds to the length L1a of the first nozzle 10.

Referring to FIG. 5, one side of each of the second nozzle 20 is connected to a corresponding second shaft 22, and the second discharge outlet 21 is provided at the other side of each of the second nozzles 20. A length L2 of each of the second nozzles 20 denotes the distance between opposite ends of thereof in one direction. The width of each of the second nozzles 20 may be non-uniform. For example, for each of the second nozzles 20, the width of an end region of is W3, and the width of a connection portion with the corresponding second shaft 22 is W4.

The second outline image 205 of the second nozzle image 200 is formed based on the outline of each of the second nozzles 20. Since it is more important to compute quickly and accurately than to make the second outline image 205 resemble the exact outline of each of the second nozzles 20, the second outline image 205 may be simplified.

The second outline image 205 may be simplified to a rectangle.

Here, a length L21 of the second outline image 205 corresponds to the length L2 of each of the second nozzles 20.

In addition, a width W31 of the second outline image 205 corresponds to the width W3 of the end region of each of the second nozzles 20. Even if the width W4 of the connection portion with the corresponding second shaft 22 is greater than the width W3 of the end region, the width W31 of the second outline image 205 may be determined based on the width W3 of the end region. A width W41 of the second outline image 205 may be the same as the width W31 of the end region.

Meanwhile, a length L2a of each of the second nozzles 20 denotes the distance between the corresponding second shaft 22 and the second discharge outlet 21. A second control image 210 is simplified to a straight line, and a length L21a of the second control image 210 corresponds to the length L2a of each of the second nozzles 20.

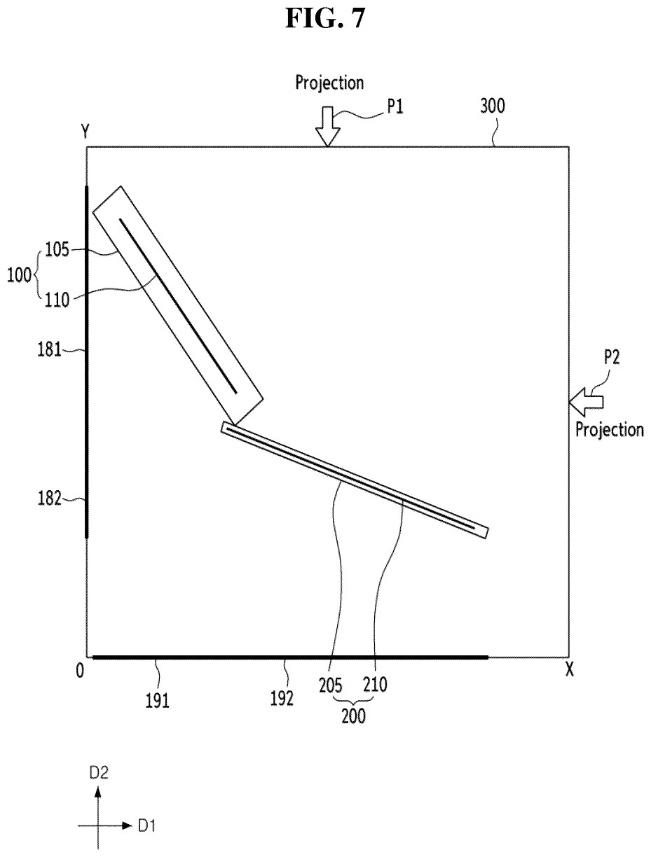

FIGS. 6 and 7 are diagrams for explaining a nozzle collision-detection method according to some embodiments of the present disclosure. Differences from what has been described with reference to FIGS. 3 to 5 will be mainly explained for convenience.

FIGS. 6 and 7 illustrate how to detect a nozzle collision using the first and second nozzle images 100 and 200 depicted in the user interface of FIG. 3.

Referring to FIG. 6, from a first side of the orthogonal coordinate system 300 (e.g., a direction parallel to the Y-axis), the first and second nozzle images 100 and 200 are projected, as indicated by reference numeral P1. A first projection image 191, onto which the first nozzle image 100 is projected, and a second projection image 192, onto which the second nozzle image 200 is projected, are formed on the X-axis of the orthogonal coordinate system 300.

In addition, from a second side of the orthogonal coordinate system 300 (e.g., a direction parallel to the X-axis), the first and second nozzle images 100 and 200 are projected, as indicated by reference numeral P2. A third projection image 181, onto which the first nozzle image 100 is projected, and a fourth projection image 182, onto which the second nozzle image 200 is projected, are formed on the Y-axis of the orthogonal coordinate system 300.

The first and third projection images 191 and 181 are formed according to the first outline image 105. The second and fourth projection images 192 and 182 are formed according to the second outline image 205.

It is determined whether the first and second projection images 191 and 192 overlap. It is also determined whether the third and fourth projection images 181 and 182 overlap.

If the first and second projection images 191 and 192 overlap and the third and fourth projection images 181 and 182 overlap, it is determined that the first and second nozzle images 100 and 200 are predicted to collide. That is, it is determined that the first nozzle 10 and the second nozzles 20 will collide.

In FIG. 6, since a gap 195 exists between the first and second projection images 191 and 192, and a gap 185 exists between the third and fourth projection images 181 and 182, it is determined that the first and second nozzle images 100 and 200 do not collide. That is, it may be determined that the first nozzle 10 and the second nozzles 20 do not collide.

Meanwhile, in some embodiments, a collision sensitivity may be set. A threshold gap may vary according to the collision sensitivity. If the gaps 195 and 185 are smaller than the threshold gap, the first nozzle 10 and the second nozzles 20 may be determined to collide.

For example, when the collision sensitivity is 0, if the gaps 195 and 185 are greater than or equal to 0, the first nozzle 10 and the second nozzles 20 may be determined not to collide. When the collision sensitivity is 5, if the gaps 195 and 185 are greater than or equal to 0 and less than 5, the first nozzle 10 and the second nozzles 20 may be determined to collide.

Referring to FIG. 7, the first nozzle image 100 is moved according to the first encoder information E1. The second nozzle image 200 is moved according to the second encoder information E2. The first encoder information E1 is a signal that controls operation of the first nozzle 10, and the first nozzle 10 may also be controlled in real time by the first encoder information E1. The second encoder information E2 is a signal that controls operation of the second nozzles 20, and the second nozzles 20 may also be controlled in real time by the second encoder information E2.

An amount of movement of the first nozzle image 100 is computed based on the first control image 110. An amount of movement of the second nozzle image 200 is computed based on the second control image 210.

The first and second projection images 191 and 192 obtained by projecting the first and second nozzle images 100 and 200 from the first side (e.g., the direction parallel to the Y-axis), as indicated by reference numeral P1, overlap. That is, the first and second projection images 191 and 192 appear connected to each other.

The third and fourth projection images 181 and 182 obtained by projecting the first and second nozzle images 100 and 200 from the second side (e.g., the direction parallel to the X-axis), as indicated by reference numeral P2, overlap. That is, the third and fourth projection images 181 and 182 appear connected to each other.

Therefore, it is determined that the first and second nozzle images 100 and 200 collide. That is, it is determined that the first nozzle 10 and the second nozzles 20 are predicted to collide.

As described above, although the nozzles (10 and 20) are controlled in real time by the encoder information (E1 and E2), in some embodiments of the present disclosure, a likelihood of nozzle collision can be quickly identified by software-based computation. Accordingly, before the nozzles (10 and 20) collide, the likelihood of collision of the nozzles (10 and 20) can be identified, and the nozzles (10 and 20) can be stopped.

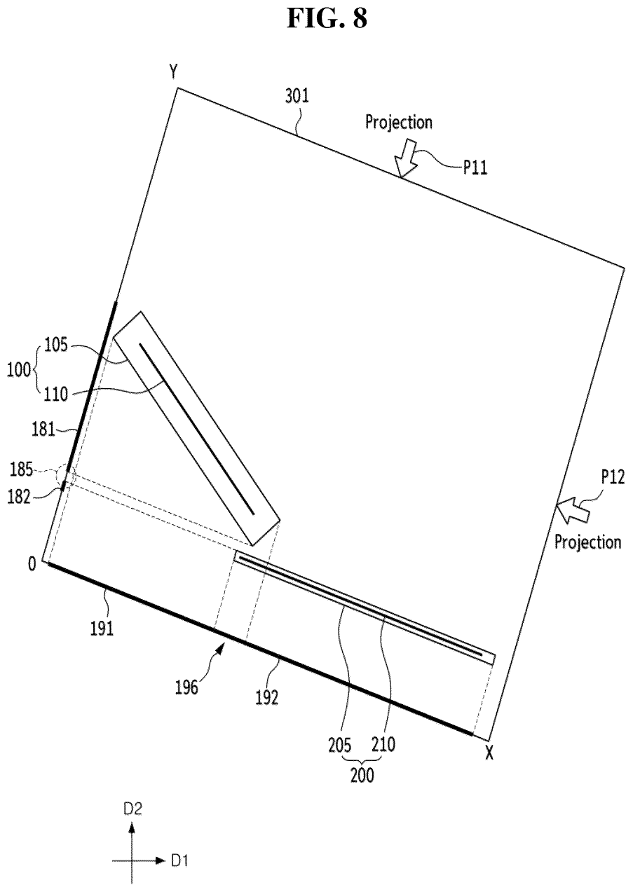

FIG. 8 is a diagram for explaining the nozzle collision-detection method according to some embodiments of the present disclosure. Differences from what has been described with reference to FIGS. 3 to 7 will be mainly explained for convenience.

Referring to FIG. 8, the first nozzle image 100 is moved according to the first encoder information E1. The second nozzle image 200 is moved according to the second encoder information E2.

In the embodiment of FIG. 7, the orthogonal coordinate system 300 does not move, whereas in the embodiment of FIG. 8, an orthogonal coordinate system 301 may move in accordance with movement of the first nozzle image 100 or the second nozzle image 200.

In FIG. 8, the orthogonal coordinate system 301 may be configured with reference to the moved second nozzle image 200. That is, the X-axis of the orthogonal coordinate system 301 may be arranged to be parallel to the second nozzle image 200. The Y-axis of the orthogonal coordinate system 301 intersects the X-axis of the orthogonal coordinate system 301 at right angles.

First and second projection images 191 and 192 obtained by projecting the first and second nozzle images 100 and 200 from the first side, as indicated by reference numeral P11, overlap. That is, the first and second projection images 191 and 192 appear connected to each other. Reference numeral 196 indicates a portion where the first and second projection images 191 and 192 overlap.

Third and fourth projection images 181 and 182 obtained by projecting the first and second nozzle images 100 and 200 from the second side, as indicated by reference numeral P12, do not overlap. That is, there exists a gap 185 between the third and fourth projection images 181 and 182.

Since the first and second projection images 191 and 192 overlap whereas the third and fourth projection images 181 and 182 do not overlap, it is determined that the first nozzle 10 and the second nozzles 20 do not collide.

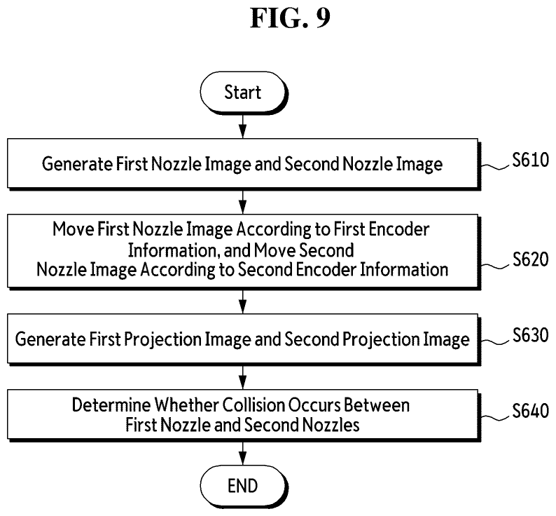

FIG. 9 is a flowchart for explaining the nozzle collision-detection method according to some embodiments of the present disclosure. Differences from what has been described with reference to FIGS. 1 to 8 will be mainly explained for convenience. The nozzle collision-detection method according to some embodiments of the present disclosure is performed by a computing device.

Referring to FIGS. 3 and 9, within the orthogonal coordinate system 300, the first nozzle image 100 corresponding to the first nozzle 10 in FIG. 1 and the second nozzle image 200 corresponding to the second nozzles 20 in FIG. 1 are generated (S610).

Thereafter, referring to FIGS. 7 and 9, the first nozzle image 100 is moved according to the first encoder information E1, and the second nozzle image 200 is moved according to the second encoder information E2 (S620).

Then, when the first nozzle image 100 is at a first position and the second nozzle image 200 is at a second position, from the first side of the orthogonal coordinate system 300, the first and second nozzle images 100 and 200 are projected, thereby generating the first and second projection images 191 and 192 (S630).

Thereafter, the first and second projection images 191 and 192 are analyzed to determine whether a collision occurs between the first nozzle 10 and the second nozzles 20 (S640). Specifically, it is determined whether the first and second projection images 191 and 192 overlap.

Additionally, from the second side of the orthogonal coordinate system 300, the first and second nozzle images 100 and 200 are projected, thereby generating the third and fourth projection images 181 and 182. It is determined whether the third and fourth projection images 181 and 182 overlap.

If a gap 195 exists between the first and second projection images 191 and 192, or a gap 185 exists between the third and fourth projection images 181 and 182, it is determined that the first and second nozzle images 100 and 200 do not collide.

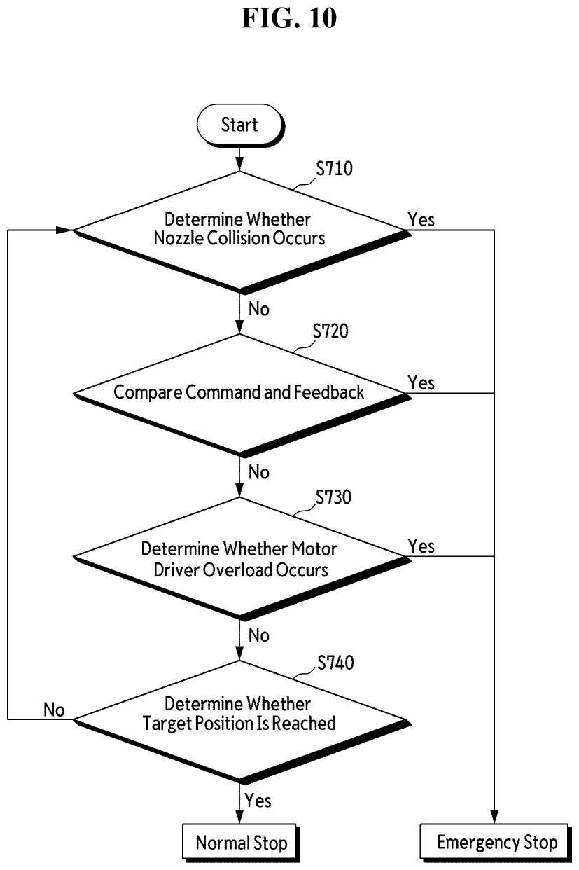

FIG. 10 is a flowchart for explaining the nozzle collision-detection method according to some embodiments of the present disclosure.

Referring to FIG. 10, it is determined whether a collision is likely to occur between the first nozzle 10 and the second nozzles 20 (S710). Specifically, using the nozzle collision-detection method described with reference to FIGS. 1 to 8, it is determined whether the first nozzle 10 and the second nozzles 20 will collide. If it is determined that a collision is likely (“Yes” in S710), operations of the first nozzle 10 and the second nozzles 20 are subjected to an emergency stop.

However, the present disclosure is not limited to the nozzle collision-detection method described with reference to FIGS. 1 to 8 (i.e., using projection images). For example, the first nozzle image 100 corresponding to the first nozzle 10 and the second nozzle image 200 corresponding to the second nozzles 20 are generated within the orthogonal coordinate system 300. A first rotation amount of the first motor that drives the first nozzle 10 is calculated based on the first encoder information E1, and a first arcuate-motion position of the first nozzle image 100 is calculated based on the first rotation amount. A second rotation amount of the second motors that drive the respective second nozzles 20 is calculated based on the second encoder information E2, and a second arcuate-motion position of the second nozzle image 200 is calculated based on the second rotation amount. By analyzing the first and second arcuate-motion positions, it is possible to determine whether a collision will occur between the first nozzle 10 and the second nozzles 20. The first nozzle 10 may be controlled in real time according to the first encoder information E1, and the second nozzles 20 may be controlled in real time according to the second encoder information E2.

Thereafter, if it is determined that a collision is unlikely (“No” in S710), a command and feedback are compared (S720). Specifically, a command (or target position) and feedback (or actual position) according to the command are compared, and it is determined whether the result of the comparison is less than a set value. If the result of the comparison exceeds the set value (“Yes” in S720), operations of the first nozzle 10 and the second nozzles 20 are subjected to an emergency stop.

Thereafter, if the comparison result is less than the set value (“No” in S720), it is determined whether an overload has occurred in motor drivers (i.e., a first motor driver corresponding to the first nozzle and a second motor driver corresponding to the second nozzles) (S730). If an overload is determined to occur (“Yes” in S730), operations of the first nozzle 10 and the second nozzles 20 are subjected to an emergency stop.

Thereafter, if it is determined that no overload has occurred (“No” in S730), it is determined whether a target position has been reached (S740). If the target position has been reached (“Yes” in S740), operations of the first nozzle 10 and the second nozzles 20 are normally stopped. If the target position has not been reached (“No” in S740), the nozzle collision-detection method according to some embodiments of the present disclosure returns to S710.

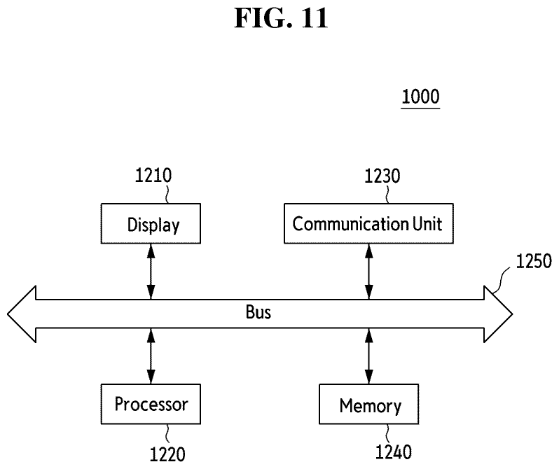

FIG. 11 is a block diagram for explaining a nozzle collision-detection apparatus according to some embodiments of the present disclosure. Hereinafter, differences from what has been described with reference to FIGS. 1 to 10 will be mainly explained for convenience.

Referring to FIG. 11, a controller (or nozzle collision-detection apparatus) 1000 may include a display 1210, a processor 1220, a communication unit 1230, a memory 1240, a bus 1250, and an input/output interface.

Various components such as the display 1210, the processor 1220, the communication unit 1230, and the memory 1240 are connected to and communicate with one another via the bus 1250 (i.e., exchange control messages and data).

The processor 1220 may include at least one of a central processing unit (CPU), an application processor (AP), or a communication processor (CP). The processor 1220 may execute operations or data processing related to control and/or communication of at least one of the other components of the semiconductor manufacturing apparatus.

The display 1210 may include, for example, a liquid crystal display (LCD), a light-emitting diode (LED) display, an organic light-emitting diode (OLED) display, a micro-electromechanical systems (MEMS) display, or an electronic paper display. The display 1210 may display various content (e.g., text, images, video, icons, and/or symbols) to a user. The display 1210 may include a touch screen and may receive, for example, touch, gesture, proximity, or hovering input using an electronic pen or a part of a user's body.

The communication unit 1230 enables external communication over a network, which may include both wired and wireless schemes. Wireless communication may include cellular communication using at least one of LTE, LTE-Advanced (LTE-A), Code Division Multiple Access (CDMA), Wideband CDMA (WCDMA), Universal Mobile Telecommunications System (UMTS), Wireless Broadband (WiBro), or Global System for Mobile Communications (GSM). Wireless communication may also include at least one of Wi-Fi (wireless fidelity), Li-Fi (light fidelity), Bluetooth, Bluetooth Low Energy (BLE), Zigbee, Near Field Communication (NFC), Magnetic Secure Transmission, Radio Frequency (RF), or a Body Area Network (BAN). Wireless communication may further include Global Navigation Satellite Systems (GNSS), such as Global Positioning System (GPS), Global Navigation Satellite System (GLONASS), BeiDou, or Galileo (a European global satellite-based navigation system). Wired communication may include at least one of Universal Serial Bus (USB), High-Definition Multimedia Interface (HDMI), Recommended Standard 232 (RS-232), Power Line Communication, Plain Old Telephone Service (POTS), or a computer network (e.g., LAN or WAN).

The memory 1240 may include volatile memory (e.g., DRAM, SRAM, or SDRAM) and/or non-volatile memory (e.g., one-time programmable ROM (OTPROM), PROM, EPROM, EEPROM, mask ROM, flash ROM, flash memory, PRAM, RRAM, MRAM, a hard drive, or a solid-state drive (SSD)). The memory 1240 may include internal memory and/or external memory.

The memory 1240 stores instructions for performing the nozzle collision-detection method described with reference to FIGS. 1 to 10.

For example, the memory 1240 stores instructions that, when executed by the processor 1220, cause the processor 1220 to: generate, within an orthogonal coordinate system, a first nozzle image corresponding to a first nozzle and a second nozzle image corresponding to second nozzles; move the first nozzle image according to first encoder information and move the second nozzle image according to second encoder information; when the first nozzle image is at a first position and the second nozzle image is at a second position, generate a first projection image and a second projection image by projecting the first nozzle image and the second nozzle image from a first side of the orthogonal coordinate system; and determine whether a collision occurs between the first nozzle and the second nozzles by analyzing the first projection image and the second projection image.

The memory 1240 may further store instructions that cause the processor 1220 to determine that the first nozzle and the second nozzles do not collide when a first gap exists between the first and second projection images.

The memory 1240 may further store instructions that cause the processor 1220, when the first nozzle image is at the first position and the second nozzle image is at the second position, to: generate a third projection image and a fourth projection image by projecting the first nozzle image and the second nozzle image from a second side (different from the first side) of the orthogonal coordinate system; analyze the third and fourth projection images; and determine that the first nozzle and the second nozzles collide when the first projection image and the second projection image overlap, or when the third and fourth projection images overlap.

Although embodiments of the present disclosure have been described above with reference to the accompanying drawings, one of ordinary skill in the art will understand that various modifications and other equivalent embodiments can be made without departing from the technical spirit or essential characteristics of the present disclosure. Accordingly, the above-described embodiments are to be understood as illustrative in all respects and not limiting.

What is claimed is:

1. A nozzle collision-detection method performed by a computing device, comprising:
generating, within an orthogonal coordinate system, a first nozzle image corresponding to a first nozzle and a second nozzle image corresponding to a second nozzle;
moving the first nozzle image according to first encoder information and moving the second nozzle image according to second encoder information;
when the first nozzle image is at a first position and the second nozzle image is at a second position, generating a first projection image and a second projection image by projecting the first nozzle image and the second nozzle image from a first side of the orthogonal coordinate system; and
determining whether a collision occurs between the first nozzle and the second nozzle by analyzing the first projection image and the second projection image.

2. The nozzle collision-detection method of claim 1, wherein when a first gap exists between the first projection image and the second projection image, it is determined that the first nozzle and the second nozzle do not collide.

3. The nozzle collision-detection method of claim 1, wherein the orthogonal coordinate system is configured with reference to the second nozzle image and moves in accordance with movement of the second nozzle image.

4. The nozzle collision-detection method of claim 1, wherein the first nozzle image includes: a first control image whose movement is controlled according to the first encoder information; and a first outline image that surrounds the first control image and is formed based on an outline of the first nozzle.

5. The nozzle collision-detection method of claim 4, wherein
the second nozzle image includes: a second control image whose movement is controlled according to the second encoder information; and a second outline image that surrounds the second control image and is formed based on an outline of the second nozzle, and
the determining of whether a collision occurs between the first nozzle and the second nozzle comprises determining, based on whether the first outline image and the second outline image collide, whether a collision occurs between the first nozzle and the second nozzle.

6. The nozzle collision-detection method of claim 4, wherein the first outline image is a polygonal simplification of the first nozzle.

7. The nozzle collision-detection method of claim 4, wherein a width of an end region of the first outline image is equal to or greater than a width of an end region of the first nozzle.

8. The nozzle collision-detection method of claim 4, wherein
the first nozzle has a length in a first direction and a width in a second direction,
a maximum distance of the first outline image in the first direction is equal to a maximum distance of the first nozzle in the first direction, and
a maximum distance of the first outline image in the second direction is different from a maximum distance of the first nozzle in the second direction.

9. The nozzle collision-detection method of claim 1, further comprising:
when the first nozzle image is at the first position and the second nozzle image is at the second position, generating a third projection image and a fourth projection image by projecting the first nozzle and the second nozzle image from a second side of the orthogonal coordinate system, the second side being different from the first side;
analyzing the third and fourth projection images; and
when the first projection image and the second projection image overlap and the third and fourth projection images overlap, determining that the first nozzle and the second nozzle collide.

10. The nozzle collision-detection method of claim 1, further comprising:
setting a collision sensitivity, wherein a threshold gap varies according to the collision sensitivity; and
when a gap between the first projection image and the second projection image is less than the threshold gap, determining that the first nozzle and the second nozzle collide.

11. The nozzle collision-detection method of claim 1, wherein
the first nozzle is controlled in real time according to the first encoder information, and
the second nozzle is controlled in real time according to the second encoder information.

12. The nozzle collision-detection method of claim 1, further comprising:
when it is determined that a collision does not occur between the first nozzle and the second nozzle, comparing a command and feedback according to the command and determining whether a result of the comparison is less than a set value; and
when the result of the comparison exceeds the set value, performing an emergency stop of operations of the first nozzle and the second nozzle.

13. The nozzle collision-detection method of claim 12, further comprising:
when the result of the comparison is less than the set value, determining whether an overload has occurred in a first motor driver corresponding to the first nozzle and a second motor driver corresponding to the second nozzle; and
when an overload is determined to have occurred, performing an emergency stop of the operations of the first nozzle and the second nozzle.

14. A nozzle collision-detection method performed by a computing device, comprising:
generating, within an orthogonal coordinate system, a first nozzle image corresponding to a first nozzle and a second nozzle image corresponding to a second nozzle;
calculating, based on first encoder information, a first rotation amount of a first motor that drives the first nozzle, and calculating, based on the first rotation amount, a first arcuate-motion position of the first nozzle image;
calculating, based on second encoder information, a second rotation amount of a second motor that drives the second nozzle, and calculating, based on the second rotation amount, a second arcuate-motion position of the second nozzle image; and
determining whether a collision occurs between the first nozzle and the second nozzle by analyzing the first arcuate-motion position and the second arcuate-motion position.

15. The nozzle collision-detection method of claim 14, wherein
the first nozzle is controlled in real time according to the first encoder information, and
the second nozzle is controlled in real time according to the second encoder information.

16. A nozzle collision-detection apparatus comprising:
a communication unit;
a display;
a processor; and
a memory storing instructions that, when executed by the processor, cause the processor to: generate, within an orthogonal coordinate system, a first nozzle image corresponding to a first nozzle and a second nozzle image corresponding to a second nozzle; move the first nozzle image according to first encoder information and move the second nozzle image according to second encoder information; when the first nozzle image is at a first position and the second nozzle image is at a second position, generate a first projection image and a second projection image by projecting the first nozzle image and the second nozzle image from a first side of the orthogonal coordinate system; and determine whether a collision occurs between the first nozzle and the second nozzle by analyzing the first projection image and the second projection image.

17. The nozzle collision-detection apparatus of claim 16, wherein the memory further stores instructions that cause the processor to determine that the first nozzle and the second nozzle do not collide when a first gap exists between the first projection image and the second projection image.

18. The nozzle collision-detection apparatus of claim 16, wherein the orthogonal coordinate system is configured with reference to the second nozzle image and moves in accordance with movement of the second nozzle image.

19. The nozzle collision-detection apparatus of claim 16, wherein
the first nozzle image includes: a first control image whose movement is controlled according to the first encoder information; and a first outline image that surrounds the first control image and is formed based on an outline of the first nozzle,
the second nozzle image includes: a second control image whose movement is controlled according to the second encoder information; and a second outline image that surrounds the second control image and is formed based on an outline of the second nozzle; and
the determining of whether a collision occurs between the first nozzle and the second nozzle includes determining, based on whether the first outline image and the second outline image collide, whether a collision occurs between the first nozzle and the second nozzle.

20. The nozzle collision-detection apparatus of claim 16, wherein the memory further stores instructions that cause the processor to: when the first nozzle image is at the first position and the second nozzle image is at the second position, generate a third projection image and a fourth projection image by projecting the first nozzle image and the second nozzle image from a second side of the orthogonal coordinate system, the second side being different from the first side; analyze the third and fourth projection images; and determine that the first nozzle and the second nozzle collide when the first projection image and the second projection image overlap, and when the third and fourth projection images overlap.
